(19) United States
(12) Patent Application Publication
(10) Pub. No.: US 2025/0149892 A1
(43) Pub. Date: May 8, 2025

(54) Electrical Power Apparatus

(71) Applicant: Enoda LTD, London, Greater London (GB)

(72) Inventors: Andrew John Scobie, London, Greater London (GB); Ludwig Johann Limmer, London, Greater London (GB)

(21) Appl. No.: 18/833,487

(22) PCT Filed: Dec. 20, 2022
(86) PCT No.: PCT/IB2022/062543

§ 371 Date: Jul. 26, 2024

(30) Foreign Application Priority Data
Jan. 27, 2022 (AU) 2022900140

(51) Int. Cl. H02J 3/28; H01M 8/0656; H02J 3/00; H02J 3/01; H02J 3/38

(52) U.S. Cl. CPC H02J 3/28; H01M 8/0656; H02J 3/007; H02J 3/01; H02J 3/38; H01M 2250/10; H02J 2300/30

(57) ABSTRACT

An electrical power apparatus for coupling between an electrical power supply and one or more electrical power loads includes: a plurality of dynamically dispatchable electrical energy storage components providing at least one of dynamically dispatchable energy storage thereto and energy retrieval therefrom; and a controller to dynamically control the operation of the one or more dynamically dispatchable energy storage components in order to dynamically match the electrical power supply to the one or more loads by dynamically storing energy in one or more of the dynamically dispatchable electrical energy storage components when the available electric power exceeds that required by the one or more loads, and/or dynamically supplying electrical energy from one or more of the dynamically dispatchable electrical energy storage components when the available electric power is less than that required by the one or more loads.

### CROSS-REFERENCE APPLICATION

This application claims priority to Australian Patent Application No. 2022900140, filed Jan. 27, 2022, which is incorporated herein by reference in its entirety.

### TECHNICAL FIELD

The present invention relates to the supply of electrical power, and more particularly to maintaining target characteristics of that supply in the face of unpredictably varying sources and sinks of electrical power.

### BACKGROUND

Climate change continues to drive transition from coal and gas-based sources of electrical power to renewable sources such as solar, wind, geothermal, and tidal power, for example. However, the electricity grid infrastructure that transports electrical power from the locations of the sources generating that power to the locations of its consumption by loads/sinks was not developed to take account of the highly variable and unpredictable nature of renewable energy sources, making the grid unstable and not fit for purpose.

Due to this and other factors, the actual cost of providing electrical power to consumers is now dominated by the costs of maintaining the characteristics of the mains power supply within target ranges. In terms of the supply of mains electrical power, the major characteristics are AC voltage, frequency, harmonic content, and power factor (quantifying the phase lag between voltage and current).

In view of the above, there is an urgent need to develop technologies that can maintain electrical power with predictable and stable characteristics in the face of unpredictable varying renewable energy and consumption by consumers.

Climate science shows that a rapid transition toward net-zero emissions of greenhouse gases (GHG) is required to limit global warming to below 2° C. relative to pre-industrial levels. The available data indicates that the energy sector is still today's main emitter of GHG. Thus, decarbonisation of the energy sector is crucial. A GHG-neutral energy sector is also the basis for an emission reduction in all other GHG emitting sectors. However, energy sector GHG neutrality is unlikely without a comprehensive expansion of renewable power generation.

It is desired to overcome or alleviate one or more difficulties of the prior art, or to at least provide a useful alternative.

### SUMMARY

In accordance with some embodiments of the present invention, there is provided an electrical power apparatus for coupling between an electrical power supply and one or more electrical power loads, including:
a plurality of dynamically dispatchable electrical energy storage components providing at least one of dynamically dispatchable energy storage thereto and energy retrieval therefrom; and
a controller to dynamically control the operation of the one or more dynamically dispatchable energy storage components in order to dynamically match the electrical power supply to the one or more loads by dynamically storing energy in one or more of the dynamically dispatchable electrical energy storage components when the available electric power exceeds that required by the one or more loads, and/or dynamically supplying electrical energy from one or more of the dynamically dispatchable electrical energy storage components when the available electric power is less than that required by the one or more loads;
wherein the dispatchable electrical energy storage components operate at different timescales, including at least one timescale sufficient to remove or reduce harmonic distortion in the electric power supply; and
wherein the dynamically dispatchable electrical energy storage components include at least one of a dynamically dispatchable hydrogen production and storage component providing dynamically dispatchable energy storage thereto, and a dynamically dispatchable generator fueled at least in part by hydrogen and providing dynamically dispatchable energy retrieval therefrom.

In some embodiments, the plurality of dynamically dispatchable electrical energy storage components provide only dynamically dispatchable energy retrieval therefrom. In some other embodiments, the plurality of dynamically dispatchable electrical energy storage components provide only dynamically dispatchable energy storage thereto. In yet further embodiments, the plurality of dynamically dispatchable electrical energy storage components provide both dynamically dispatchable energy storage thereto and dynamically dispatchable energy retrieval therefrom.

In some embodiments, the dynamically dispatchable electrical energy storage components include the dynamically dispatchable hydrogen production and storage component.

In some embodiments, at least a portion of hydrogen generated by the dynamically dispatchable hydrogen production and storage component is not used by the apparatus to generate energy but is transported elsewhere.

In some embodiments, the plurality of dynamically dispatchable electrical energy storage components includes an electromagnetic energy storage component operating at a timescale sufficient to remove or reduce harmonic distortion in the electric power supply by operating as a dynamically variable sink of electric power, or as a dynamically variable source of electrical power.

In some embodiments, the electromagnetic energy storage component includes a first dynamically reconfigurable magnetic core configured to operate as a dynamically variable sink of electric power, and a second dynamically reconfigurable magnetic core coupled to the electric power supply and configured to operate as a dynamically variable source of electrical power.

In some embodiments, the electromagnetic energy storage component includes a set of capacitors to store electrical energy.

In some embodiments, the or each electromagnetic energy storage component includes at least one dynamically reconfigurable magnetic core coupled to the electric power supply and configured to mitigate harmonic distortion in the electric power supply.

In some embodiments, the plurality of dynamically dispatchable electrical energy storage components includes an electromagnetic energy generation component.

In some embodiments, the apparatus further includes a controller and a switching matrix of power electronics converter cells coupled to the dynamically dispatchable hydrogen production and storage component, wherein the controller is configured to dynamically cause the switching matrix to act as at least one of a rectifier to convert AC to DC, and an inverter to convert DC to AC.

In some embodiments, the controller is further configured to control the switching matrix to dynamically connect and disconnect the dynamically dispatchable hydrogen production and storage component from the electric power supply.

In some embodiments, each of the power electronics converter cells includes SiC, GaN or insulated-gate bipolar power transistors and respective diodes configured to perform high speed switching.

In some embodiments, in an electrical power apparatus as claimed above, a computer-implemented process, including dynamically controlling the operation of the one or more dynamically dispatchable energy storage components in order to dynamically match the electrical power supply to the one or more loads by dynamically storing energy in one or more of the dynamically dispatchable electrical energy storage components when the available electric power exceeds that required by the one or more loads, and/or dynamically supplying electrical energy from one or more of the dynamically dispatchable electrical energy storage components when the available electric power is less than that required by the one or more loads.

### BRIEF DESCRIPTION OF THE DRAWINGS

Some embodiments of the present invention are hereinafter described, by way of example only, with reference to the accompanying drawings, wherein:

FIG. 1 is a high-level block diagram of an electrical power apparatus in accordance with the described embodiments of the present invention;

FIG. 2 is a block diagram of an electrical power apparatus in accordance with an embodiment of the present invention;

FIGS. 3 to 5 are schematic diagrams illustrating respective transfer functions of the apparatus;

FIGS. 6 to 8 are block diagrams illustrating components/sub-systems of the apparatus respectively implementing the transfer functions of FIGS. 3 to 5;

FIG. 9 is a circuit diagram of a power electronics converter matrix of an electromagnetic subsystem of the apparatus, showing its connections to electrolysis modules; and

FIG. 10 is a circuit diagram of a single cell of the power electronics converter matrix.

### DETAILED DESCRIPTION

To address the difficulties described above, embodiments of the present invention include an electrical power apparatus and process for supplying electrical power and/or hydrogen. The apparatus includes a plurality of dynamically dispatchable energy storage and retrieval components, including a dynamically dispatchable hydrogen production and storage component providing dynamically dispatchable energy storage, and/or a dynamically dispatchable generator fueled at least in part by hydrogen and providing dynamically dispatchable energy. The apparatus also includes a controller to dynamically control the operation of the dynamically dispatchable energy storage and retrieval components to dynamically match the supplies of electrical energy and hydrogen gas to one or more loads.

Typically, and as in the described embodiments, there are a plurality of loads, and embodiments of the present invention are described in that context. However, it will become apparent from the following description that the capabilities of the apparatus can address the shortcomings of the prior art even when there is only one load.

The controller matches the supply of electrical energy to the electrical loads on the apparatus by dynamically controlling the operation of the energy storage and retrieval components to: (i) store energy when the available electric power exceeds that required by the loads, and (ii) supply electrical energy from the stored energy when the available electric power is less than that required by the loads. In effect, the energy storage and retrieval components act as dynamically variable loads to absorb excess energy, but rather than waste that energy as heat, for example, it is stored for subsequent reuse as either fuel, for example as industrial feedstock, to meet transportation needs, or as electrical energy when the electrical power received by the apparatus is less than that required by the external loads on the apparatus. Moreover, the absorption of excess power may include continuous power quality correction at short timescales (<1s time intervals; for example, the real-time removal of harmonics polluting the ideal sinusoidal waveform of the electrical power supply), voltage transients, over voltage, phase imbalances, or surplus energy in the system causing deviation of frequency from target, or surplus energy from renewable energy systems (wind farms, solar farms, PV systems, etc.) that may otherwise be curtailed by transmission system operators to avoid transmission line congestion. Furthermore, the apparatus also allows electrical power supply in a quasi-static manner by using excess stored energy in form of hydrogen as a blend-in fuel for base-load generation based on the combustion of natural gas.

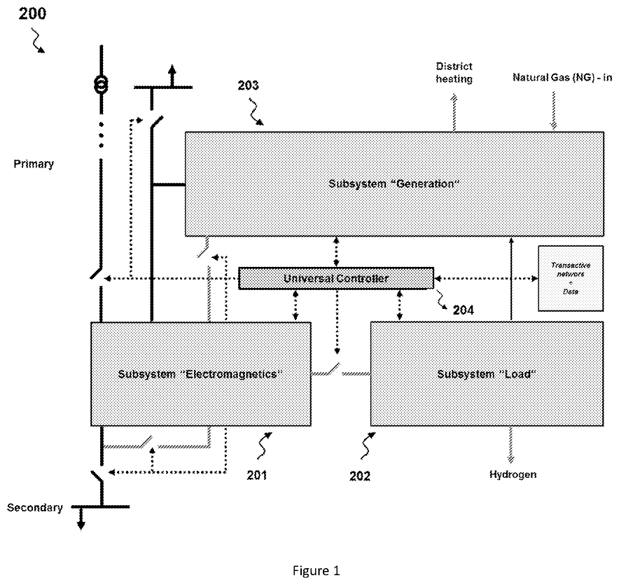

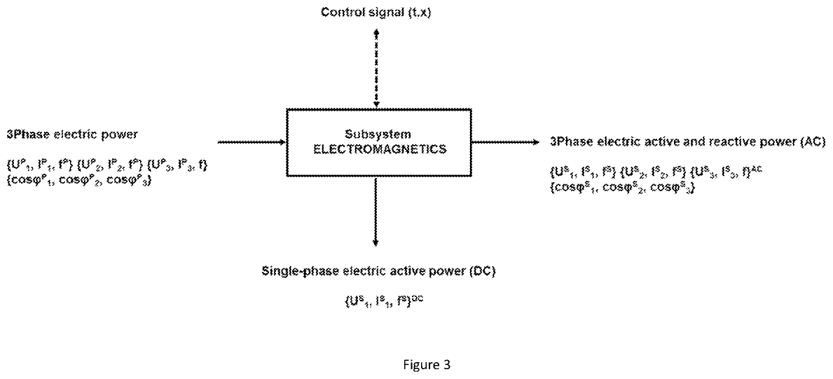

The operation of the energy ‘storage’ and retrieval components is controlled over multiple time scales, using respective different modes of energy storage. For example, FIG. 1 is a high-level block diagram of an apparatus 200 for supplying and/or absorbing electrical power (hereinafter also referred to as the “electrical power apparatus”) in accordance with an embodiment of the present invention. In this embodiment, the apparatus 200 includes an electromagnetic component or sub-system 201 operating as a dynamically variable load over very short (“real-time”) time scales, a “load” component or sub-system 202 operating as a dynamically variable load over longer time scales, and a “generation” component or sub-system 203 operating as a dynamically variable generator of electrical power, these components 201, 202, 203 being controlled by a universal controller 204. Functionally, the controlled components 201, 202, 203 implement electrical power transfer functions, as shown in FIGS. 3 to 5, respectively, and as described below.

### Apparatus Overview

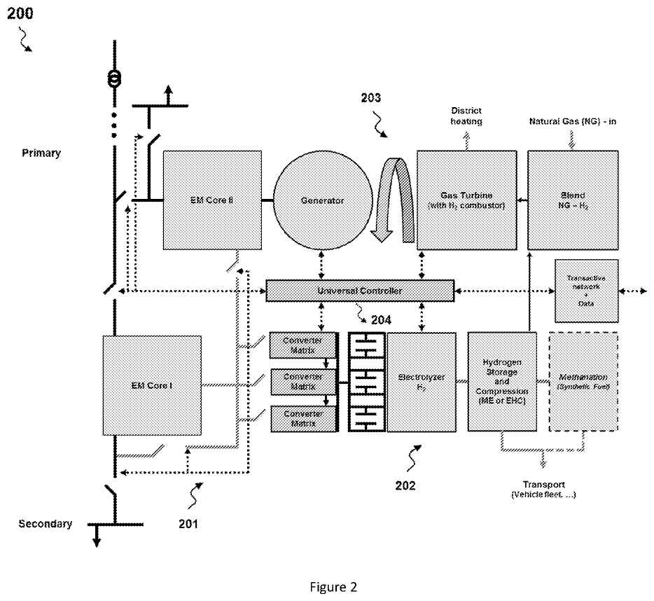

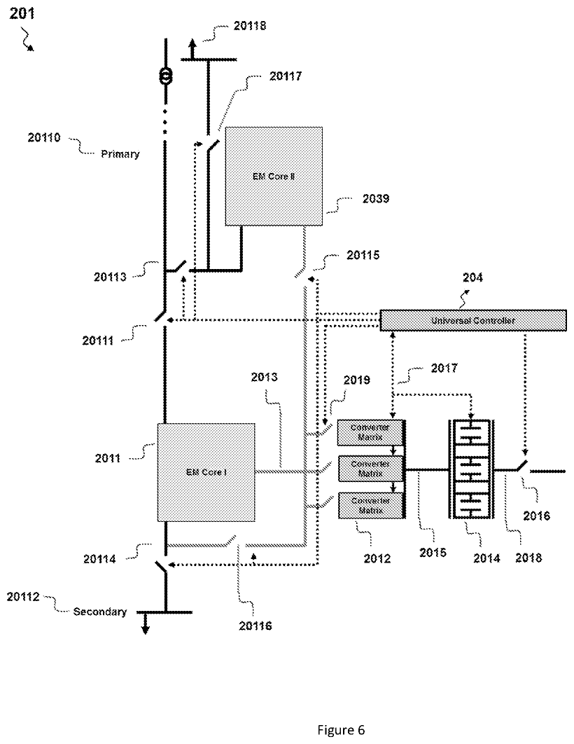

A more detailed block diagram of the apparatus 200 is shown in FIG. 2, and block diagrams of the controlled components 201, 202, 203 are shown in FIGS. 6 to 8, respectively.

As shown in FIG. 2, the electromagnetics component 201 and the generation component 203 include respective electromagnetic cores, “EM Core I” and “EM Core II”, each with primary, secondary and modulation windings wound around a magnetic core. The instantaneous current flowing through the modulation windings of either of these EM Cores at any given time determines the instantaneous electromagnetic coupling between its primary and secondary windings, and thereby allows real-time modification of the waveform at the secondary windings and the waveform at the primary windings. For example, by dynamically modulating this current at a timescale that is substantially shorter than the period of the desired output waveform, any differences between the waveform at the primary windings and the desired output waveform can be ‘corrected’ in real-time. Thus, for example, a distorted sinusoidal signal present at the primary windings can be dynamically modulated in real-time to produce the desired sinusoidal output signal at the secondary winding.

As shown in FIGS. 2 and 6, in addition to the EM Cores I and II, the electromagnetics component 201 includes a converter matrix 2012 coupled to a capacitor bank 2014 whose output is used to power a proton exchange membrane (PEM) hydrogen electrolyser 2022. The hydrogen produced by the PEM electrolyser 2022 is compressed and stored by a hydrogen storage and compression unit 2025. The compressed hydrogen can be used in a variety of different ways, as described below. However, one use is as fuel for the apparatus 200 to locally generate electrical power, either for local use to support a load 20118, or for feeding-back electric power into the grid at the primary side of the apparatus 20110. In the embodiment of FIG. 2, the hydrogen fuels an electric power generation unit, in this case a gas turbine 2034, either alone or as a mixture with natural gas. Alternatively, in some embodiments the electric power generation unit is a gas engine (with mixed fuel operation), and in some other embodiments it is a (hydrogen only) fuel cell. The gas turbine 2034 is coupled to a generator 203 that generates electric power in the form of an output signal that is provided to the EM Core II for dynamic modification to meet the electrical supply needs of the loads coupled to the apparatus 200.

### Electromagnetics Component or Sub-System 201

The electromagnetics component or sub-system 201 performs as its primary function dynamic electricity signal correction at timescales of t<1s, implementing a corresponding short timescale transfer function, as shown in FIG. 3.

Together with the EM Core II, the electromagnetics component 201 dynamically corrects the incoming electrical power signal to a reference signal within a short timescale regime of operation determined by the operating frequency of the power electronics semiconductor platform used to implement the electromagnetic component or sub-system 201. For example, in the described embodiment with SiC transistors, the dynamic correction corresponds to a frequency of approximately 400 kHz, whereas implementations with GaN transistors may operate at substantially higher frequencies.

The transfer (production) function is characterised by the following inputs and outputs. As shown in FIGS. 3 and 6, the input to the EM Core I is a time-varying 3-phase electric signal 20110 characterised by its current, voltage, frequency, and the inter-phase and intra-phase relationships between the individual phases, where the voltage represents grid voltage associated with the overlaid grid line typically denoted with voltage at the primary side.

The primary output ofthe EM Core I is also a time-varying 3-phase AC electric signal 20112 characterised by its current, voltage, frequency, and the inter-phase and intra-phase relationships between the individual phases, but its voltage represents grid voltage associated with the lower voltage (LV) grid line typically denoted with voltage at the secondary side of the apparatus 200.

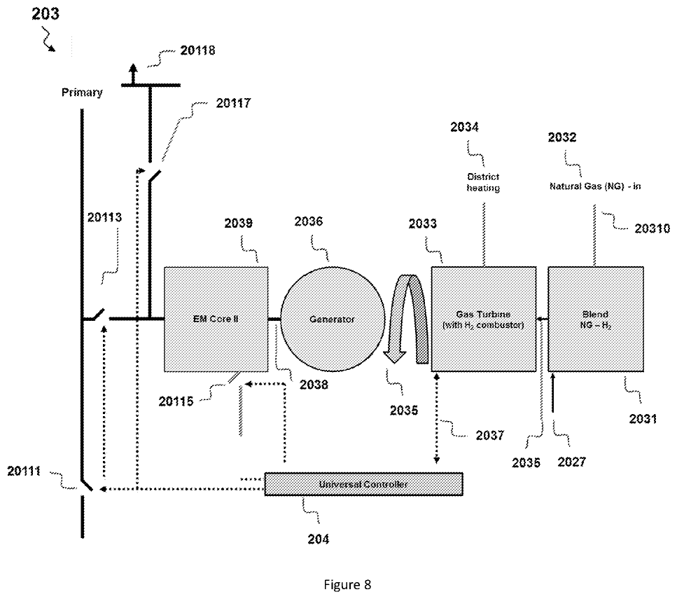

The input to the EM Core II is also a time-varying 3-phase AC electric signal 2039, as shown in FIG. 8, characterised by its current, voltage, and frequency with correctly aligned inter-phase and intra-phase relationships corresponding to (or at least closely approximating) an ideal 3-phase power signal, where the voltage represents the 3-phase voltage generated by a generator 203.

The output of the EM Core II is also a time-varying 3-phase AC electric signal 20314, characterised by its current, voltage, frequency, and the inter-phase and intra-phase relationships between the individual phases, wherein the voltage represents grid voltage associated with the higher voltage (HV) grid line typically denoted with voltage at the primary side of the apparatus 200.

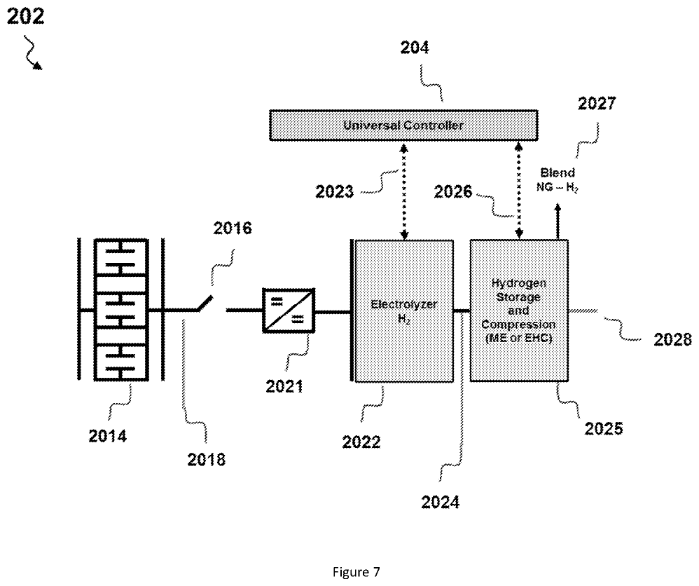

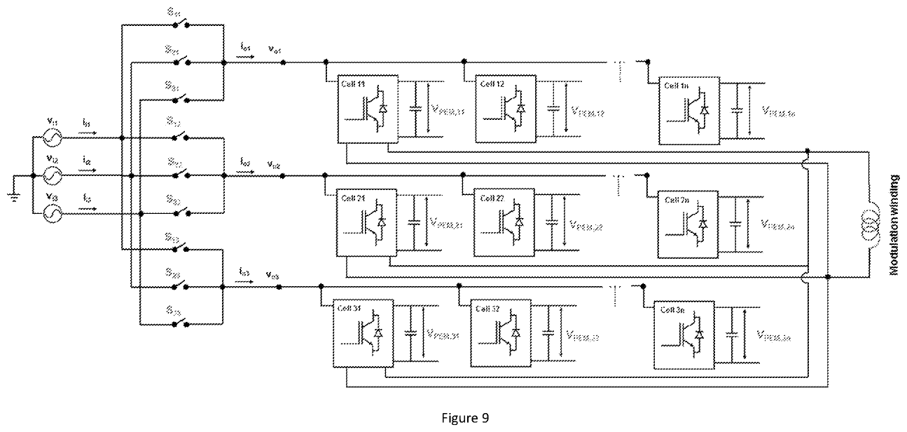

As shown in FIG. 6, the primary output 2013 ofthe EM Core I is connected to the converter matrix 2012. As shown in FIG. 9, the converter matrix 2012 is a matrix of power-electronics (PE) converter cells. The total power rating of the matrix 2012 typically exceeds the power rating of the connected Electrolyzer 2022. For example, in one embodiment, the electrolyser consists of a PEM stack with a power rating of 1 MW, and the individual cells of the matrix have a power rating of 1.5 MVA. Fast switching of the PE converter cells (for example, with SiC transistors switching at 400 kHz) at multiples of the network frequency (for example, in the case of mains power supply frequencies of 50 or 60 Hz, the switching times are <<(1/50)s or (1/60)s) enables AC/AC, AC/DC, DC/DC and DC/AC conversion that in turn dynamically couples the secondary side 20112 of EM Core I, the primary side 20110 of EM Core 12011 and EM Core 112039, and the secondary side 2038 of EM Core II. Moreover, the fast switching not only dynamically couples the HV and LV side of the grid, but also the dispatchable load (in the form of the electrolyzer 2022 (FIG. 7) in the described embodiment) and generator (in the form of the Generator 2036 (FIG. 8) in the described embodiment). The system's power flow is modified by dynamic modulation of the three-phase electromagnetic subsystems (EM Core 2011 and EM Core II 2039) magnetic flux by applying pulse width modulation (PWM) harmonisation signals to the modulation windings. The harmonisation signals are generated by fast switching of the converter matrix 2012 under control of the universal controller 204 to which it is communicatively coupled, as shown in FIG. 6.

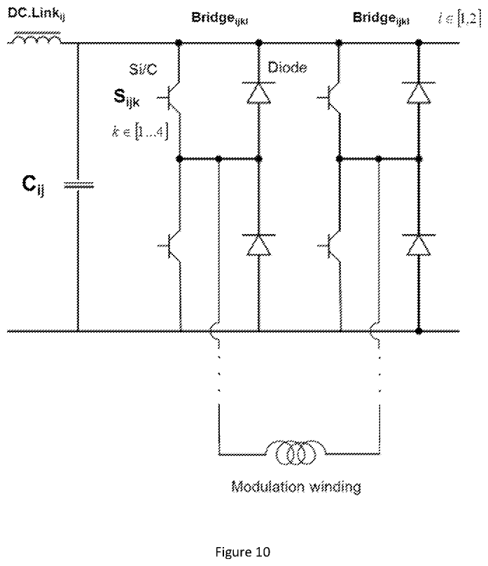

The converter matrix 2012 is configured to function as both a voltage source converter, to convert electric power from AC to direct current (DC), and as an inverter, to convert electric power from DC to AC. The voltage source converter includes a plurality of transistors and a plurality of capacitors configured to form a converter with cells connected in series, each converter cell including a pair of series connected transistors connected in parallel with a capacitor, as shown in FIG. 10. In various embodiments, the transistors are silicon carbide-based metal-oxide semiconductor field-effect transistors, insulated-gate bipolar transistors, and/or gallium nitride transistors. The AC input terminals and AC output terminals of the voltage source converter are electrically coupled to the primary and secondary winding, respectively, of the EM Core 2011 (or EM Core 2039). The DC (output) terminals ofthe voltage source converter are electrically coupled to a means for storing electrical energy, in the form of capacitors in the described embodiment. When an electrical signal from the primary AC power side 20110 is introduced to the primary winding of the EM Core 2011 (or EM Core 2039), an electromagnetic field is induced in the magnetic core. The electromagnetic field induces an electrical signal in the secondary winding.

The controller 204 is configured to receive data representing measured parameters of the input electrical signal in the primary and secondary windings and compare the measured parameters to corresponding parameters of a reference signal for the secondary winding. In the described embodiments, the measured parameters are the voltage, current, phase-shift and frequency of the actual signal prevailing at the primary and secondary side of the electromagnetic subsystem, (for example, at EM Core I and II), and the reference signal represents an ideal sinusoidal waveform with a target frequency, current and voltage. Thus, the reference signal represents an idealised waveform with desired parameters of the output signal; for example, without noise or harmonics. In the described embodiments, the data is generated by a digital-to-analogue converter (DAC) from signals received from standard voltage and current sensors coupled to the three phases of each of the Primary and Secondary sides of the electromagnetic subsystem.

The algebraic difference between individual quantities describes the geometric distance of the actual, prevailing signal at both primary and secondary side of the electromagnetic subsystem (EM Core I and II) to the prescribing reference helical surface. The controller 204 is configured to determine a harmonisation signal which, when applied to the primary winding of EM Core 2011 (or EM Core 2039), causes the output electrical signal of the secondary winding to approximate the reference signal, for example, by destructive interference. The controller 204 is configured to cause application of the harmonisation signal to the primary winding of EM Core 2011 (or EM Core 2039) using the voltage source converter 2012 as described below. Accordingly, once the harmonisation signal is applied, the output electrical signal in the secondary winding is substantially identical to the reference signal.

Coupled by means of windings at the secondary side 20112 and at the primary side 20110, the voltage source converter (converter matrix) 2012 performs AC-DC and DC-AC conversion and can operate with a switching frequency at multiples of the primary AC signal frequency. In parallel, the voltage source converter matrix 2012 can also act as a dispatchable DC supply by releasing DC current from the capacitors of the PE cells. When operating as a controllable high-speed switch to a dispatchable load, the converter can dynamically couple to an electrical (electrolysis) load to optimise (or at least improve) the electricity supply. This allows the work of electrolysis to be conducted at the lowest marginal cost.

A portion ofthe energy buffered in the capacitors can be used to provide power to generate the harmonisation signal later, thereby supporting power factor correction, voltage regulation, power quality management, and/or phase balancing as part of system frequency stabilisation in the output signal. Additionally, however, energy buffered in the capacitors can be transferred to other means for storing energy, e.g. into batteries for long-term storage, or into hydrogen by coupling the electrolyzer to the capacitors 2014.

The capacitor bank 2014 is fed by DC current from the converter matrix 2012 via a DC interconnection 2015 as illustrated in FIG. 6. The capacitor bank 2014 allows the temporal and variable storage of electric energy, and subsequent dynamic release of electric energy in accordance with a harmonisation signal 2017 generated by the universal controller 204, and at a speed that is multiple times the network frequency (i.e., switching time<<(1/50)s or (1/60)s for 50 or 60 Hz network frequencies). The capacitor bank 2014 enables dynamic and rapid storage and release of electric energy at a speed faster than the network speed.

As shown in FIG. 6, a dynamic switch 2016 controlled by the universal controller 204 enables the capacitor bank 2014 to be dynamically connected and/or disconnected to the “load” subsystem 202 (for example, hydrogen electrolysis) via DC link 2018 dynamically coupling a DC load to the electromagnetic subsystem 201, thereby enabling excess electricity to be absorbed either as storage in the capacitor bank 2014 or via direct draw from the secondary side of the EM Core I 2011, bypassing the capacitor bank located within the power electronics module which houses the AC/DC converter matrix.

### Dynamic Coupling and Isolation of EM Cores

The electromagnetic cores EM Core 1 2011 and EM Core 2 2039 can be dynamically coupled or decoupled from the grid (primary side) and the AC load (secondary side) by respective switches 20111, 20113, 20114, 20115, 20116 and 20117, which themselves are controlled by the universal controller 204, as follows.

As shown in FIG. 6, a dynamic switch 20111 enables the primary side of the EM Core I 2011 to be connected to and disconnected from the grid wherein in the latter case the dynamic load subsystem 202 is also disconnected from the grid by the simultaneous operation of switch 20115, leaving the generation subsystem 203 as the only subsystem of the apparatus to be connected to the grid. In this mode of operation, the apparatus 200 provides both a quasi-static and a dynamically controlled “generation” with avoidance of reverse power flow within the apparatus itself, where:
(i) the quasi-static operation provides AC power to local load demand 20118 (e.g., a continuous on-site power requirement when the electrical apparatus is installed at an industrial site), or as a possible alternative application backup power (e.g., a backup power supply in microgrids when these operate in an isolated, islanding condition) when connection 20117 is closed and connection 20113 is open;
(ii) the dynamic operation facilitates instantaneous generation demand with switch 20113 closed, such as required for system frequency stabilisation (fast frequency containment, automatic frequency restoration, or manual frequency restoration); and
(iii) the combined form of quasi-static and dynamic operation can provide both AC power to local load demand 20118, and AC power to the grid for frequency stabilisation service provision, with switches 20113 and 20117 both closed.

Thereby, the controller 204 is enabled to control the power rating balance between quasi-static and dynamic power supply provision (e.g., 60% base-load power rating to the local load, and 40% power rating in support of the dynamic power supply to the grid for system frequency stabilisation).

As shown in FIG. 8, the dynamic switch 20113 is operable to selectably connect or disconnect the primary side of the EM Core II 2039 to the grid wherein the latter also disconnects the generation subsystem 203 from the grid. Distinct from the dynamically operating switch 20111, in this mode of operation the apparatus 200 provides a dynamically controlled “generation” and “load”, or “load” only, to the grid, wherein the latter includes avoidance of reverse power flow within the apparatus itself. In addition, for the latter case with switch 20113 open, the apparatus 200 can also provide in parallel a quasi-static mode generation to satisfy local power demand with switch 20117 closed. In the dynamic mode of operation with switch 20113 closed, the apparatus 200 fully supports the requirement for system frequency stabilisation across all technically relevant regimes including (fast) frequency containment (FCR), automatic frequency restoration (aFRR), and manual frequency restoration (mFRR).

As shown in FIG. 6, the dynamic switch 20114 enables the secondary side of the EM Core I 2011 to be connected and disconnected to the AC load side of the grid, wherein the latter case applies when the only load acting on the electromagnetic subsystem and hence the grid is the DC load such as provided by the Electrolyzer of the dynamic load subsystem 202 and/or the quasi-static load 20118 (FIG. 6).

Similarly, the dynamic switch 20115 enables the secondary side of the EM Core II 2039 to be selectably connected to and disconnected from the converter matrix 2012, wherein the latter case applies when the dynamic load subsystem 203 is disconnected from the grid and thus the apparatus only operates as a local AC power supply.

Finally, the dynamic switch 20116 enables the secondary side of the EM Core II 2039 to be selectably connected to and disconnected from the LV AC load side 20112, wherein the latter case applies when the generation subsystem 203 is connected only to the grid; i.e., only dynamically controlled “generation” is provided by the apparatus 200.

### Dynamic Load Component or Sub-System 202

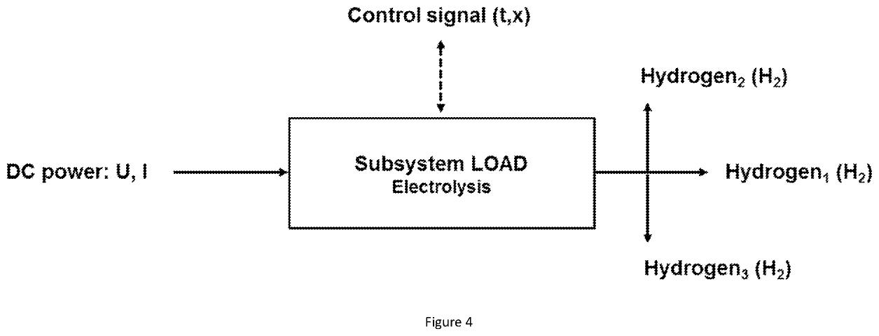

The dynamic load component 202 acts as a dynamically controlled and dispatchable load, and implements a dynamic load transfer function, as shown in FIG. 4. As shown in FIG. 7, the dynamic load component 202 includes an electrolyser 2022 (for example, an electrolyser based on the principle of proton exchange membrane (PEM) electrolysis), and a hydrogen storage tank 2024 with integrated hydrogen compression where the latter is based either on mechanical (ME) compression or electrochemical compression (EHC).

As shown in FIG. 4, the input to the dynamic load component 202 is a time-varying DC voltage signal, which provides the input for the electrolyser 2022. The DC current is drawn from the converter matrix 2012, which is coupled to both electromagnetic cores EM Core I 2011 and EM Core 112039, through connection 2018 with the option of drawing surplus DC power from the capacitor module 2014. In order to generate hydrogen, ionised water is supplied to the electrolyzer 2022. The output of the dynamic load component 202 includes a time-varying dispatch of hydrogen (Hydrogen₁) 2027 to the hydrogen compression and storage unit 2025 using a high-pressure (typically 30-40 bar) pipe connection 2024, wherein the compression and storage unit 2025 can supply hydrogen on demand to the “generation” component 203 using a high-pressure pipe connection 2027 which connects the hydrogen compression and storage unit 2025 to the blend module 2031, as shown in FIG. 7. In some embodiments, hydrogen generated and stored in compressed form by the dynamic load component 202 may also be used for auxiliary purposes such as transport, where a high-/low-pressure connection 2028 provides hydrogen to a filling station.

The dynamic load component 202 includes a DC-DC converter 2021 that controls the input power by modulating the electrical output of the converter matrix and/or capacitor bank to provide the lower electrical voltage required by the PEM stacks of the electrolyser 2022 (for example, 3×568 V, 3×568 V/50 Hz according to IEC 60038 for grid connection of an electrolyzer rated with a connecting power of approximately 1.707 MVA, or 3×400 V/50 Hz according to IEC 60038 for grid connection of an electrolyzer rated with a connecting power of approximately 500 kVA).

In the described embodiment, the electrolyser 2022 is based on the principle of Proton exchange membrane (PEM) electrolysis and is coupled to the electromagnetics component 202 via the AC-DC converter (i.e., the converter matrix) 2012 and the capacitor bank 2014, and the DC-DC converter 2021. The electrolyser 2022 can in principle be of standard design and commercially available (e.g., an H-TEC ME 450/1400 electrolyser as described at https://www.h-tec.com/en/products/detail/h-tec-pem-electrolyser-me450-1400/me450-1400, with integrated AC-/DC converter, and a quasi-static operation mode enabled through an integrated control module. However, to enable not only seamless power rating scaling via parallel coupling of individual PEM stack units (e.g., commercially available 110 kVA PEM stacks), but more importantly the operation of these under high-speed dynamic control and variable hydrogen production rates, PEM modules of known power rating (e.g., 110 kVA) are configured in a matrix configuration corresponding to the converter matrix configuration, as shown in FIG. 9. Thus, each PEM module is powered by a corresponding one of the matrix cells, where the power rating of each matrix cell (as shown in FIG. 10) is matched to the power rating of the corresponding PEM module that it powers. Alternatively, the PEM modules can be grouped so that each group of multiple cells provides the power to operate a corresponding PEM module. This provides not only the capability for rating extension by adding further PEM modules, but by means of direct connection to the DC-DC converter and AC-/DC-converter matrix, this configuration allows the PEM stacks to be fed by a variable voltage input as prevails at the secondary side 20112 of the apparatus 200 and direct control of each PEM stack module by the controller 204.

In the context of dynamic control of PEM modules with variable hydrogen production output, prior art electrolysers are too constrained to operate as a dynamically dispatchable load with a variable load rating (power consumption range) and a fast response time, as a response to changes in grid conditions. To enable frequency stabilisation with variable power consumption within short timescales as is required for frequency containment and automatic frequency restoration. Thereby, the electric power supply and draw of each matrix cell or set of cells is controlled by the universal controller 204.

The electrical capacity of the electrolyser 2022 limits the maximum rate of hydrogen production, but which is also directly proportional to (and thus also limited by) the input DC electrical power available from the Converter Matrix 2012.

The universal controller 204 issues control signals to the electrolyser 2022, allowing either rapid start-up (activation) or load level change (load shifting) of the electrolyser (for example, <30 sec for start-up, and <2 see for load shifting). The PEM electrolyser 2022 is operated in one of two modes: a voltage mode or a current mode.

The compression and storage unit 2025 enables temporary hydrogen storage before utilisation. The storage tank (for example, a carbon-fibre reinforced composite tank) can sustain elevated pressures (for example, up to approximately 300 bar), and can be of modular configuration like that of the PEM stacks, to enable scaling of storage capacity.

The supply of hydrogen as a blend fuel to the gas turbine 2033 is enabled by the universal controller 204 issuing a control signal to the storage unit 2025 that causes the storage unit 2025 to release a defined amount of hydrogen to the fuel gas blend module 2031 via a pipeline 2027, as shown in FIG. 7, based on the prevailing hydrogen volume within the storage tank at the time of the request, where the fuel blend composition in terms of the ratio hydrogen to natural gas is determined using a “droop control characteristic”. As will be understood by those skilled in the art, the droop control characteristic allows the determination of the required natural gas supply for the mixed fuel composition as a function of the pre-determined amount of hydrogen draw (supply) from the storage tank and the prevailing load level of the gas turbine.

An auxiliary pipeline 2028 enables the transport of stored hydrogen from the hydrogen storage unit 2025 for first auxiliary uses (represented as “Hydrogen₂” in the transfer function of FIG. 4). Hydrogen is released from the storage module to a connected natural gas pipeline (for example, a connection to a fueling station for H₂-based transportation) by receiving a control signal 2026, as shown in FIG. 7, from the universal controller 204 to release stored hydrogen from the storage tank, thus providing further capacity for hydrogen production. The auxiliary use of Hydrogen₂ may include the use of hydrogen to produce synthetic fuel and may be accomplished through the coupling of a methanation process to the apparatus 200.

### Generation Component or Sub-System 203

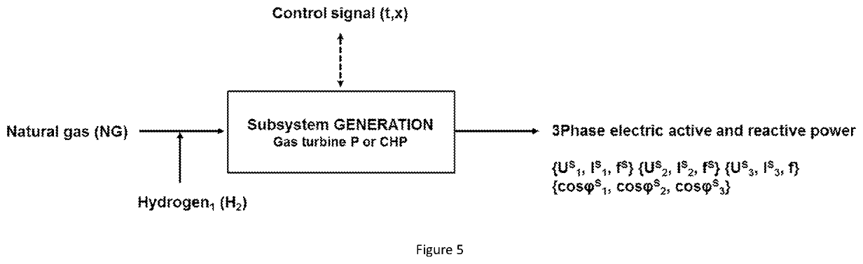

The generation component 203 implements a transfer (production) function, as shown in FIG. 5, and acts as a dynamically controlled dispatchable generator of electric power, with effectively instantaneous response by injecting electric power at the primary side 20110 (in general the higher-voltage side of the electricity grid) of the apparatus.

As shown in FIG. 5, the input to the transfer (production) function includes a time varying feed-in of gaseous fuel, either in form of pure natural gas, pure hydrogen or a fuel mixture of natural gas and hydrogen, and the resulting output is a time varying dispatch of electric power to the primary side 20110 of the apparatus.

As shown in FIG. 8, the fuel blend module 2031 supplies gaseous fuel to the combustor of the gas turbine or gas engine 2033, enabling the mixture of both natural gas (NG) 2032 and hydrogen 2027. The fuel gas blend module 2031 receives hydrogen from the hydrogen storage unit 2025 via the high-pressure pipeline 2027, and natural gas from local natural gas infrastructure 20311

The gas turbine or gas engine 2033 is selected to have a fast start-up time (e.g., ≤5 minutes from cold state to nominal power rating, e.g. for gas turbines with a nominal power rating in the range of 1-8 MW) to match the requirements for frequency services, (for example, in various embodiments an aero-derivative gas turbine, a Siemens SGT-A05 series turbine, a Solar Turbine Taurus 60-70, an OPRA radial gas turbine, or a KAWASAKI GTB35 series turbine).

These turbines or engines can use blended gaseous fuel consisting of natural gas (NG) and blended-in hydrogen ranging from 0% to 100%, i.e., in the latter case a pure hydrogen-based fuel.

In some embodiments, the apparatus includes or is coupled to a heat recovery steam generator (HRSG) via a pipeline 2034 to provide the services of a Combined Heat & Power (CHP) system, extracting thermal energy contained in the exhaust gas. This can be used for purposes including but not limited to hot water generation for district heating or the generation of process steam for industrial facilities.

Depending upon the specific gas turbine or engine type used, in some embodiments the apparatus includes a high-performance gear box 2035 to enable the synchronization of the gas turbine rotor speed—in cases where the design rotor speed of the gas turbine is not equal to the nominal rotor speed of the generator (typically the case for aeroderivative gas turbines)—to the rotor speed of the generator which is in principle congruent to the reference signal frequency (e.g., 50 Hz or 60 Hz, corresponding to 3000 rpm or 3600 rpm, respectively), i.e. the frequency of the AC electrical system.

In the described embodiments, the generator 2036 can be an industrial synchronous power generator of type 2-pole air-cooled design, with matching MVA size to the MW rating of the gas turbine or engine 2034, adjusted to the accumulated power rating of EM Core I and EM Core II. In some embodiments, the generator 2036 is a commercially available power generator such as available through BRUSH low power rating industrial generator sets (with range of 0.3 to 10 MVA) or a Siemens industrial 2-pole SGen series generator (from the SIGENTICS series, with range of 0.3 to 20 MVA).

To provide either peak load or load-following variable generation, the universal controller 204 issues control signals based on a droop-control characteristic via a bi-directional data interface 2037 to the gas turbine or engine.

AC-AC electric coupling 2038 of the generator to the secondary side of EM Core II 2039 enables adaptation of the output voltage of the generator 2036 to the target grid voltage, acting at the primary side of EM Core II 2039.

With the gate switches 20113 and 20114 open (as set by the universal controller 204 as shown in FIG. 8), the electromagnetic subsystem and load components 201, 202 are disconnected from the secondary side of the apparatus 200, enabling the apparatus to operate in a generation-only mode. This mode of operation can be either of type continuous operation or standby operation where the latter can function as either peak-mode generation or standby (backup) generation, thus providing different states of operation of the apparatus, including islanded operation and grid attached operation, and hence being able to provide services to the grid or local energy loads.

With the gate switch 20111 in open state (as set by the universal controller 204 as shown in FIG. 8), the generation component 203 is disconnected from the primary side 20110 and hence from the grid, enabling the apparatus to operate in a ‘load-only’ mode or a ‘power quality correction only” mode. The ‘load-only’ mode of operation can be either of type continuous operation or as standby operation.

The continuous mode of operation typically represents continuous hydrogen production, such as when surplus energy from renewable energy generation is available. The standby mode is typically employed for system frequency stabilisation.

With the gate switch 20111 and switch 20115 in open condition (as set by the universal controller 204 as shown in FIG. 8), the EM Core II and hence the generation unit is disconnected from the primary side 20110 of the grid as well as from the secondary AC load side 20112 of the grid, thus avoiding reverse power flow within the apparatus. This enables the apparatus 200 to operate in a “Power-quality-only” and “Load-only” mode of operation using EM-Core I 2011 only.

When embodied or otherwise configured to provide a dynamically dispatchable load (whether with or without dispatchable power generation), the apparatus supports carbon neutrality by storing excess power (including in the form of hydrogen) for subsequent re-use rather than as waste heat, and the marginal cost of the stored power (whether in the form of hydrogen or otherwise) is effectively zero. Multiple instances of the apparatus distributed through the electricity grid can be used to provide grid stability.

Alternatively, when embodied or otherwise configured to provide a dynamically dispatchable generator only, distributed instances of the apparatus nevertheless contribute to grid stability, provide inertia, and protect against mechanical damage caused by signal perturbations.

It will be apparent from the description above that those embodiments of the present invention include an autonomous decentralized device for the provision of energy system stability while reducing entropic (for example, thermal) energy loss and the marginal cost of provision of energy to the consumer, achieved through harmonisation of the electrical signal to a reference signal based on modulation of electric energy in time and space, and modal shifts to different energy forms.

Many modifications will be apparent to those skilled in the art without departing from the scope of the present invention.

1. An electrical power apparatus for coupling between an electrical power supply and one or more electrical power loads, including:
a plurality of dynamically dispatchable electrical energy storage components providing at least one of dynamically dispatchable energy storage thereto and energy retrieval therefrom; and
a controller to dynamically control the operation of the one or more dynamically dispatchable energy storage components in order to dynamically match the electrical power supply to the one or more loads by dynamically storing energy in one or more of the dynamically dispatchable electrical energy storage components when the available electric power exceeds that required by the one or more loads, and/or dynamically supplying electrical energy from one or more of the dynamically dispatchable electrical energy storage components when the available electric power is less than that required by the one or more loads;
wherein the dispatchable electrical energy storage components operate at different timescales, including at least one timescale sufficient to remove or reduce harmonic distortion in the electric power supply; and
wherein the dynamically dispatchable electrical energy storage components include at least one of a dynamically dispatchable hydrogen production and storage component providing dynamically dispatchable energy storage thereto, and a dynamically dispatchable generator fueled at least in part by hydrogen and providing dynamically dispatchable energy retrieval therefrom.

2. The apparatus of claim 1, wherein the plurality of dynamically dispatchable electrical energy storage components provide only dynamically dispatchable energy retrieval therefrom.

3. The apparatus of claim 1, wherein the plurality of dynamically dispatchable electrical energy storage components provide only dynamically dispatchable energy storage thereto.

4. The apparatus of claim 1, wherein the plurality of dynamically dispatchable electrical energy storage components provide both dynamically dispatchable energy storage thereto and dynamically dispatchable energy retrieval therefrom.

5. The apparatus of claim 3, wherein the dynamically dispatchable electrical energy storage components include the dynamically dispatchable hydrogen production and storage component.

6. The apparatus of claim 5, wherein at least a portion of hydrogen generated by the dynamically dispatchable hydrogen production and storage component is not used by the apparatus to generate energy but is transported elsewhere.

7. The apparatus of claim 1, wherein the plurality of dynamically dispatchable electrical energy storage components includes an electromagnetic energy storage component operating at a timescale sufficient to remove or reduce harmonic distortion in the electric power supply by operating as a dynamically variable sink of electric power, or as a dynamically variable source of electrical power.

8. The apparatus of claim 7, wherein the electromagnetic energy storage component includes a first dynamically reconfigurable magnetic core configured to operate as a dynamically variable sink of electric power, and a second dynamically reconfigurable magnetic core coupled to the electric power supply and configured to operate as a dynamically variable source of electrical power.

9. The apparatus of claim 7, wherein the electromagnetic energy storage component includes a set of capacitors to store electrical energy.

10. The apparatus claim 7, wherein the or each electromagnetic energy storage component includes at least one dynamically reconfigurable magnetic core coupled to the electric power supply and configured to mitigate harmonic distortion in the electric power supply.

11. The apparatus of claim 1, wherein the plurality of dynamically dispatchable electrical energy storage components includes an electromagnetic energy generation component.

12. The apparatus of claim 1, including a controller and a switching matrix of power electronics converter cells coupled to the dynamically dispatchable hydrogen production and storage component, wherein the controller is configured to dynamically cause the switching matrix to act as at least one of a rectifier to convert AC to DC, and an inverter to convert DC to AC.

13. The apparatus of claim 12, wherein the controller is further configured to control the switching matrix to dynamically connect and disconnect the dynamically dispatchable hydrogen production and storage component from the electric power supply.

14. The apparatus of claim 12, wherein each of the power electronics converter cells includes SiC, GaN or insulated-gate bipolar power transistors and respective diodes configured to perform high speed switching.

15. In an electrical power apparatus as claimed in claim 1, a computer-implemented process, including dynamically controlling the operation of the one or more dynamically dispatchable energy storage components in order to dynamically match the electrical power supply to the one or more loads by dynamically storing energy in one or more of the dynamically dispatchable electrical energy storage components when the available electric power exceeds that required by the one or more loads, and/or dynamically supplying electrical energy from one or more of the dynamically dispatchable electrical energy storage components when the available electric power is less than that required by the one or more loads.

16. A computer-readable storage medium having stored thereon processor-executable instructions that, when executed by one or more processors, cause the one or more processors to execute the process of claim 15.
